(19) United States
(12) Patent Application Publication
(10) Pub. No.: US 2006/0087811 A1
(43) Pub. Date: Apr. 27, 2006

(54) Heat dissipation device for lowering temperature of an airflow

(75) Inventor: Li He, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: Foxconn Technology Co., Ltd, Tu-Cheng City (TW)

(21) Appl. No.: 11/216,231

(22) Filed: Aug. 31, 2005

(30) Foreign Application Priority Data
Oct. 21, 2004 (CN) 200410051952.2

(51) Int. Cl. G06F 1/20

(52) U.S. Cl. 361/687

(57) ABSTRACT

A heat dissipation device includes a fan (20) generating an airflow, a hydrophilic member (44) deposited on a flowing path of the airflow, a case (30) containing liquid therein and a pipe (42) fluidically connecting the hydrophilic member (44) and the case (30). The hydrophilic member (44) includes a body (440) with wick structure therein for absorbing the liquid and a plurality of airways (442) in the body (440). The pipe (42) has a wick structure which leads the liquid to the body (440) by capillary action of the wick structure. The liquid in the hydrophilic member (44) is drawn into the airflow and heated by the airflow into vapor, so that the liquid absorbs a great amount of heat from the airflow.

### BACKGROUND

1. Field

The present invention relates to a heat dissipation device, and more particularly to a heat dissipation device which can lower temperature of an airflow generated by the heat dissipating device by supplying liquid to the airflow, wherein the liquid is evaporated into vapor by absorbing heat from the airflow.

2. Prior Art

As computer technology continues to advance, electronic components such as central processing units (CPUs) of computers are being made to provide faster operational speeds and greater functional capabilities. When a CPU operates at a high speed in a computer enclosure, its temperature increases greatly. It is desirable to dissipate the heat quickly, for example by using a heat dissipation device attached to the CPU in the enclosure. This allows the CPU and other electronic components in the enclosure to function within their normal operating temperature ranges, thereby assuring the quality of data management, storage and transfer.

Usually, a conventional heat dissipation device placed inside of a computer enclosure comprises a heat sink defining a plurality of cooling fins and a fan. The heat sink absorbs heat from a cooled component and dissipates the heat through the fins to ambient air in the computer enclosure. The fan is used to generate a forced airflow through the fins of the heat sink thereby enhancing the heat dissipation effect from the fins to the ambient air. However, due to more and more heat produced by the cooled component and dissipating in the computer enclosure, the temperature of the air in the computer enclosure increases significantly, whereby the temperature of the forced airflow produced by the fan is high. When the high-temperature forced airflow passes through the fins, the heat exchange between the forced airflow and the fins is not sufficient. Thus, heat dissipation efficiency of the heat dissipation device is low.

### SUMMARY OF THE INVENTION

What is needed is a heat dissipation device which can reduce the temperature of an airflow.

A heat dissipation device in accordance with a preferred embodiment of the present invention comprises a fan generating an airflow, a hydrophilic member deposited on a flowing path of the airflow, and a case offering the hydrophilic member with liquid. The case contains liquid therein and fluidically connects with the hydrophilic member via a pipe having a core therein. The hydrophilic member comprises a body with wick structure and a plurality of airways in the body. The liquid in the hydrophilic member is drawn into the airflow and heated by the airflow to vapor state, so that the liquid absorbs a great amount of heat from the airflow. The temperature of the airflow is thus lowered.

Other objects, advantages and novel features will become more apparent from the following detailed description when taken in conjunction with the accompanying drawings, in which:

### BRIEF DESCRIPTION OF THE DRAWINGS

FIG. 1 is an assembled view of a heat dissipation device in accordance with a preferred embodiment of the present invention with a heat sink, and a fan being placed on the heat sink; and

FIG. 2 is an assembled view of a heat dissipation device in accordance with another embodiment of the present invention placed on a computer enclosure.

### DETAILED DESCRIPTION OF THE INVENTION

Reference will now be made to the drawings to describe the present invention in detail.

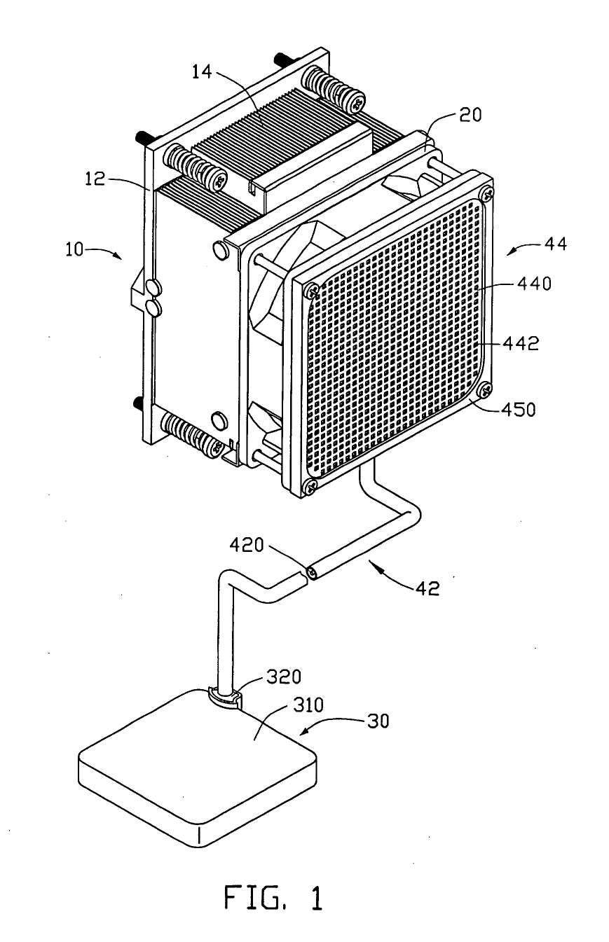

FIG. 1 illustrates a heat dissipation device in accordance with a preferred embodiment of the present invention with a heat sink 10. The heat sink 10 comprises a base 12 and a plurality of fins 14 extending from the base 12. The heat dissipation device comprises a first member for generating an airflow, such as a fan 20 mounted on the fins 14, a second member containing liquid therein for lowering temperature of the airflow, such as a hydrophilic member 44 located at an intake of the fan 20, and a third member for offering the second member with liquid. The third member comprises a case 30 for carrying the liquid therein and a pipe 42 connecting the case 30 to the hydrophilic member 44. The liquid is supplied from the case 30 to the hydrophilic member 44 along the pipe 42.

The hydrophilic member 44 comprises a body 440 and a bracket 450 carrying the body 440 thereon. The body 440 made by porous material, comprises wick structure for absorbing liquid and a plurality of airways 442 offering an access for the airflow to flow through the body 440. The bracket 450 is used to mount the body 440 on the fan 20, and has a mounting portion engaging with the fan 20. In this embodiment, four screws (not labeled) are used to secure the bracket 450 to a frame of the fan 20 thereby mounting the hydrophilic member 44 on the fan 20.

The case 30 is made of transparent or semitransparent plastics or glass, which is convenient to observe water level of the liquid. Top of the case 30 has a top wall 310. The top wall 310 defines a liquid outlet 320 communicating with the pipe 42.

The pipe 42 has a core 420 therein for guiding the liquid from the case 30 to the body 440 of the hydrophilic member 44. The core 420 is made of porous material, such as cotton yarn, or sponge impregnated with hydrophilic material. One end of the pipe 42 connects with the case 30 and is inserted into the liquid through the top wall 310. The other end of the pipe 42 connects with the hydrophilic member 44. The pipe 42 and the hydrophilic member 44 are made independently and then connected together. The liquid is sucked into the body 440 via the core 420 by capillary action of wick structure of the core 420. In addition to the wick structure, the body 440 is impregnated with hydrophilic material such that the liquid delivered to the body 440 by the core 420 can be quickly spread to every part of the body 440 and the body 440 is always maintained in a wet condition.

In operation, when the fan 20 generates the airflow flowing through the heat sink 10, the liquid permeated in the body 440 is drawn into the airflow and heated by the airflow into a vapor state thereby absorbing heat from the airflow and lowering the temperature thereof. Since the heat absorbed by the liquid from the airflow equals to latent heat of the liquid for phase change from liquid to vapor, the amount of heat absorbed by the liquid is considerably quite large. Accordingly, the airflow is cooled and its temperature is lowered by a large degree. The cooled airflow flows to the fins 14 of the heat sink 10. Difference in temperature between the cooled airflow and the fins 14 is greatly increased. Heat exchange between the cooled airflow and the fins 14 is sufficient to ensure that heat on the fins 14 is dissipated quickly. It is feasible that in an alternative embodiment the hydrophilic member 44 is deposited at an outlet of the fan 20.

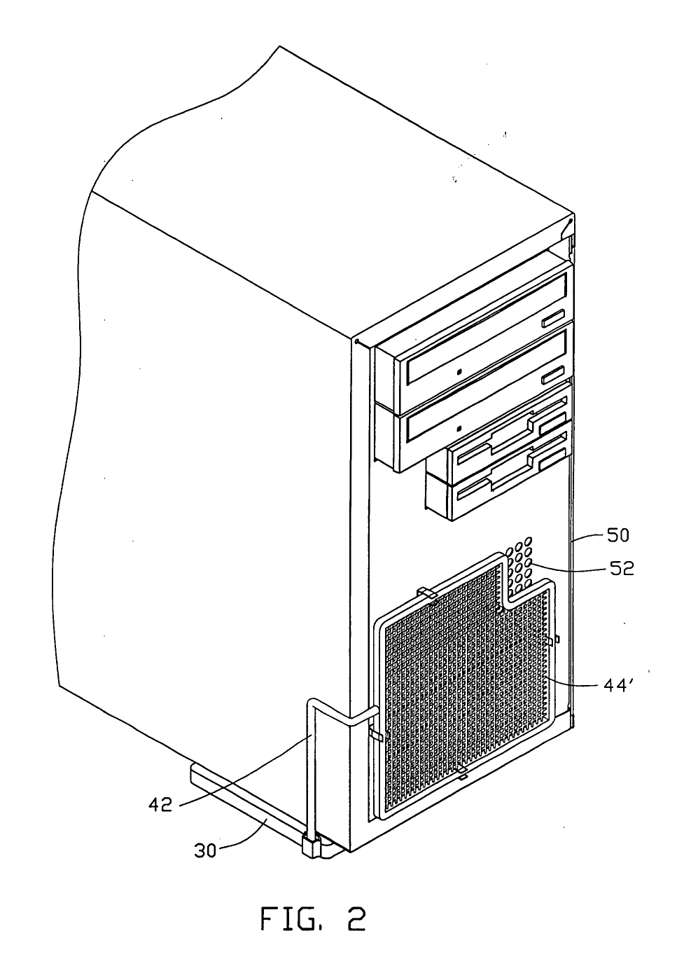

Referring to FIG. 2, a heat dissipation device is shown in accordance with another embodiment of the present invention with a computer enclosure 50. The heat dissipation device has a hydrophilic member 44′, a pipe 42 and a case 30 containing liquid therein. Like the first embodiment, the pipe 42 provides the hydrophilic member 44′ with the liquid in the case 30 so that the hydrophilic member 44′ always maintains in a wet condition. The computer enclosure 50 defines a plurality of air inlets 52 at one side thereof for air entering the computer enclosure 50. The hydrophilic member 44′ is deposited on an outside of the computer enclosure 50 and covers some of the air inlets 52. When an airflow passes through the hydrophilic member 44′ into the enclosure 50, the liquid in the hydrophilic member 44′ is drawn into and heated by the airflow to vapor state, whereby the airflow is cooled. The cooled airflow enters the computer enclosure 50 through the air inlets 52 to lower the temperature in the computer enclosure 50, whereby environmental temperature around electronic components in the computer enclosure 50 is lowered. The airflow absorbs the heat of the electronic components and finally takes the heat away from the computer enclosure 50 by a system fan therein.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A heat dissipation device comprising:
a first member generating an airflow;
a second member being deposited on a flowing path of the airflow; and a third member fluidically connected with the second member and containing liquid therein;
wherein the liquid in the third member is supplied to the second member and from second member the liquid is drawn into the airflow and heated by the airflow to vapor state thereby absorbing heat from the airflow.

2. The heat dissipation device as claimed in claim 1, wherein the first member is a fan, the second member being placed on an intake of the fan.

3. The heat dissipation device as claimed in claim 1, wherein the second member is located at an outlet of the first member.

4. The heat dissipation device as claimed in claim 1, wherein the second member defines a plurality of airways by which the airflow flows through the second member.

5. The heat dissipation device of claim 1, wherein the second member is a hydrophilic member comprising a body with wick structure, and the liquid permeating in the body.

6. The heat dissipation device as claimed in claim 5, wherein the second member further comprises a bracket for carrying the body thereon and mounting the body on the first member.

7. The heat dissipation device as claimed in claim 1, wherein the third member comprises a case for containing the liquid therein and a pipe fluidically connecting the case to the second member, the liquid being supplied from the case to the second member along the pipe.

8. The heat dissipation device as claimed in claim 7, wherein the pipe comprises a core made of wick structure, the liquid flowing along the pipe to the second member by capillary action of the wick structure.

9. A heat dissipation assembly comprising:
a computer enclosure defining a plurality of air inlets at a side thereof for air entering the computer enclosure;
a hydrophilic member containing liquid therein, the hydrophilic member being deposited on the side of the computer enclosure and covering the air inlets;
a case offering the hydrophilic member with the liquid; and
a pipe fluidically connecting the case and the hydrophilic member whereby the liquid is supplied from the case to the hydrophilic member through the pipe;
wherein the liquid in the hydrophilic member absorbs heat of an airflow passing through the hydrophilic member and the air inlets and into the computer enclosure.

10. The heat dissipation device of claim 9, wherein the hydrophilic member comprises wick structure therein, the liquid being supplied to the hydrophilic member by capillary action of the wick structure.

11. The heat dissipation device of claim 9, wherein the hydrophilic member defines a plurality of airways therein, the airflow flowing through the airways into the computer enclosure.

12. The heat dissipation device of claim 9, wherein the case fluidically connects with the hydrophilic member via a pipe, the liquid flowing along the pipe into the hydrophilic member.

13. A heat dissipation device for cooling an airflow for use to take heat away from a computer component, comprising:
a case containing liquid therein;
a wet member through which the airflow flows; and
a pipe fluidically connecting the case and the wet member and providing the wet member with the liquid in the case; wherein the liquid in the wet member enters the airflow and heated by the airflow into vapor.

14. The heat dissipation device of claim 13, wherein the wet member and the pipe each comprise a wick structure.

15. The heat dissipation device of claim 14, wherein the wick structures of the wet member and the pipe are impregnated with hydrophilic material.

16. The heat dissipation device of claim 15, wherein the wet member is placed on a computer enclosure.

17. The heat dissipation device of claim 16, wherein the wet member covers air inlets in the computer enclosure.

18. The heat dissipation device of claim 15, wherein the wet member is placed on a heat sink.

19. The heat dissipation device of claim 18, wherein a fan is provided between the wet member and the heat sink.

20. The heat dissipation device of claim 18, wherein the wet member is provided between a fan and the heat sink.
